(19) United States
(12) Patent Application Publication
(10) Pub. No.: US 2012/0155458 A1
(43) Pub. Date: Jun. 21, 2012

(54) Repeated Lost Packet Retransmission in a TCP/IP Network

(75) Inventors: ISAAC LARSON, MINNEAPOLIS, MN (US); SIVA SANKAR ADIRAJU, FREMONT, CA (US); SENTHILKUMAR NARAYANASAMY, SAN JOSE, CA (US)

(73) Assignee: BROCADE COMMUNICATIONS SYSTEMS, INC., San Jose, CA (US)

(21) Appl. No.: 12/972,713

(22) Filed: Dec. 20, 2010

(51) Int. Cl. H04L 12/56

(52) U.S. Cl. 370/389

(57) ABSTRACT

Periodically retransmitting of multiply lost TCP/IP packets until either an ACK is received or the timeout finally occurs. By retransmitting the packet more than the once as done with prior art SACK approaches, there is a possibility of not having to wait until the timeout period elapses if one of the other retransmissions successfully transits the network. If the packet is successfully received and acknowledged before the timeout period ends, then the more extensive timeout procedures need not be invoked and traffic is much less affected.

### BACKGROUND

A storage area network (SAN) may be implemented as a high-speed, special purpose network that interconnects different kinds of data storage devices with associated data servers on behalf of a large network of users. Typically, a storage area network includes high performance switches as part of the overall network of computing resources for an enterprise. The storage area network is usually clustered in close geographical proximity to other computing resources, such as mainframe computers, but may also extend to remote locations for backup and archival storage using wide area network carrier technologies. Fibre Channel networking is typically used in SANs although other communications technologies may also be employed, including Ethernet and IP-based storage networking standards (e.g., iSCSI, FCIP (Fibre Channel over IP), etc.).

As used herein, the term “Fibre Channel” refers to the Fibre Channel (FC) family of standards (developed by the American National Standards Institute (ANSI)) and other related and draft standards. In general, Fibre Channel defines a transmission medium based on a high speed communications interface for the transfer of large amounts of data via connections between varieties of hardware devices.

FC standards have defined limited allowable distances between FC switch elements. Fibre Channel over IP (FCIP) refers to mechanisms that allow the interconnection of islands of FC SANs over IP-based (internet protocol-based) networks to form a unified SAN in a single FC fabric, thereby extending the allowable distances between FC switch elements to those allowable over an IP network. For example, FCIP relies on IP-based network services to provide the connectivity between the SAN islands over local area networks (LANs), metropolitan area networks (MANs), and wide area networks (WANs). Accordingly, using FCIP, a single FC fabric can connect physically remote FC sites allowing remote disk access, tape backup, and live mirroring.

In an FCIP implementation, FC traffic is carried over an IP network through a logical FCIP tunnel. Each FCIP entity on either side of the IP network works at the session layer of the OSI model. The FC frames from the FC SANs are encapsulated in IP packets and transmission control protocol (TCP) segments and transported in accordance with the TCP layer in a single TCP session. For example, an FCIP tunnel is created over the IP network and a TCP session is opened in the FCIP tunnel.

One common problem in TCP/IP networks is packet loss. Each packet must be acknowledged. Usually this is done sequentially as the packets arrive, but in certain cases packets may be lost or corrupted and following packets received correctly. To address this problem selective acknowledge or SACK was developed. SACK is detailed in RFC 2018, which is hereby incorporated by reference. When a receiver detects the condition, the receiver sends a SACK. The transmitter responds by retransmitting the missing or corrupted packets. This avoids the transmitter having to go through a packet timeout process to determine the need to retransmit the packets, and then generally all of the following packets.

While SACK has provided improvements, in some cases the retransmitted packets may not arrive or may again be corrupted in transmission. Normal practice then has the receiver just discarding the corrupted packets. The packets are only again retransmitted after the transmitter times out the packets. Thus in the case of multiple problems with the same packet, the prior art has to wait for the timeout mechanism. While this may be acceptable with certain types of traffic, it is troublesome with storage traffic, such as FCIP traffic, as longer sequences must be retransmitted and the timeout periods have a more significant affect than with other types of traffic, such as user interaction with a website.

### SUMMARY

Implementations described and claimed herein address the foregoing problems of multiple loss of the same TCP/IP packet by periodically retransmitting the corrupted or lost packet until either an ACK is received or the timeout finally occurs. By retransmitting the packet more than the once as done with prior art SACK approaches, there is a possibility of not having to wait until the timeout period elapses if one of the other retransmissions successfully transits the network. If the packet is successfully received and acknowledged before the timeout period ends, then the more extensive timeout procedures need not be invoked and traffic is much less affected.

### BRIEF DESCRIPTIONS OF THE DRAWINGS

FIG. 1 illustrates an example FCIP configuration using distinct per-priority TCP sessions within a single FCIP tunnel over an IP network.

FIG. 2 illustrates example IP gateway devices communicating over an IP network using distinct per priority TCP sessions within a single FCIP.

FIG. 3 illustrates a logical block diagram of portions of a TCP/IP interface according to the present invention.

FIG. 4 is a flowchart of prior art SACK operation.

FIG. 5 is a flowchart of SACK operation according to the present invention.

### DETAILED DESCRIPTIONS

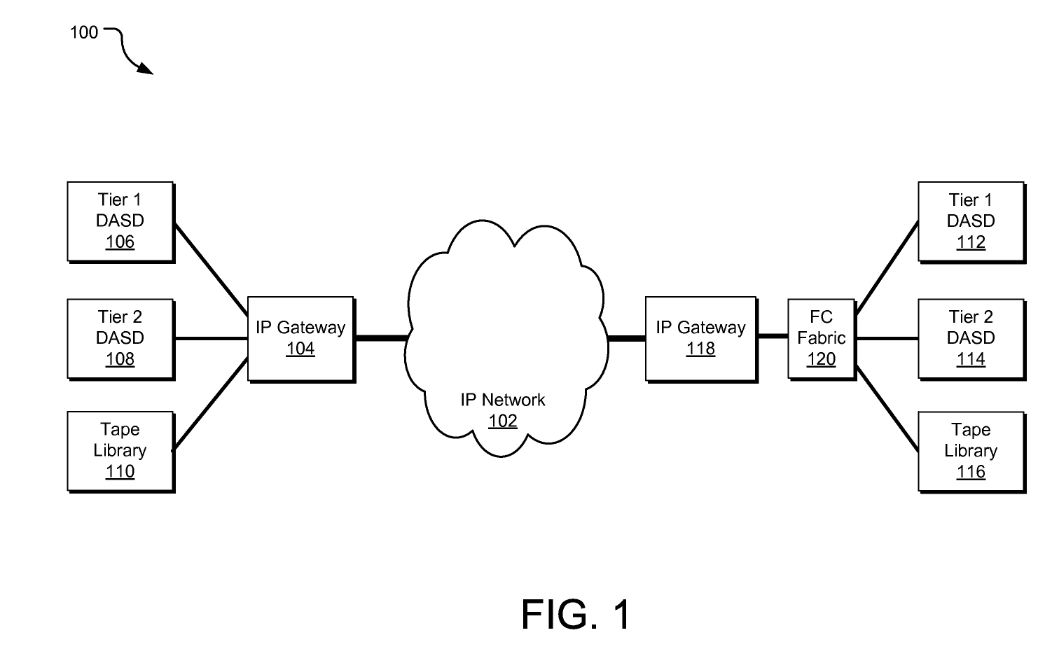

FIG. 1 illustrates an example FCIP configuration 100 using distinct per-priority TCP sessions within a single FCIP tunnel over an IP network 102. An IP gateway device 104 (e.g., an FCIP extender), couples example FC source nodes (e.g., Tier 1 Direct Access Storage Device (DASD) 106, Tier 2 DASD 108, and a tape library 110) to the IP network 102 for communication to example FC destination nodes (e.g., Tier 1 DASD 112, Tier 2 DASD 114, and a tape library 116, respectively) through an IP gateway device 118 (e.g., another FCIP extender) and an FC fabric 120. Generally, an IP gateway device interfaces to an IP network. In the specific implementation illustrated in FIG. 1, the IP gateway device 118 interfaces between an IP network and an FC fabric, but other IP gateway devices may include tape extension devices, Ethernet network interface controllers (NICs), host bus adapters (HBAs), and director level switches). An example application of such an FCIP configuration would be a remote data replication (RDR) scenario, wherein the data on the Tier 1 DASD 106 is backed up to the remote Tier 1 DASD 112 at a high priority, the data on the Tier 2 DASD 108 is backed up to the remote Tier 2 DASD 114 at a medium priority, and data on the tape library 110 is backed up to the remote tape library 116 at a low priority. In addition to the data streams, a control stream is also communicated between the IP gateway devices 104 and 118 to pass class-F control frames.

The IP gateway device 104 encapsulates FC packets received from the source nodes 106, 108, and no in TCP segments and IP packets and forwards the TCP/IP-packet-encapsulated FC frames over the IP network 102. The IP gateway device 118 receives these encapsulated FC frames from the IP network 102, “de-encapsulates” them (i.e., extracts the FC frames from the received IP packets and TCP segments), and forwards the extracted FC frames through the FC fabric 120 to their appropriate destination nodes 112, 114, and 116. It should be understood that each IP gateway device 104 and 118 can perform the opposite role for traffic going in the opposite direction (e.g., the IP gateway device 118 doing the encapsulating and forwarding through the IP network 102 and the IP gateway device 104 doing the de-encapsulating and forwarding the extracted FC frames through an FC fabric). In other configurations, an FC fabric may or may not exist on either side of the IP network 102. As such, in such other configurations, at least one of the IP gateway devices 104 and 118 could be a tape extender, an Ethernet NIC, etc.

Each IP gateway device 104 and 118 includes an IP interface, which appears as an end station in the IP network 102. Each IP gateway device 104 and 118 also establishes a logical FCIP tunnel through the IP network 102. The IP gateway devices 104 and 118 implement the FCIP protocol and rely on the TCP layer to transport the TCP/IP-packet-encapsulated FC frames over the IP network 102. Each FCIP tunnel between two IP gateway devices connects two TCP end points in the IP network 102. Viewed from the FC perspective, pairs of switches export virtual E_PORTs or virtual EX_PORTs (collectively referred to as virtual E_PORTs) that enable forwarding of FC frames between FC networks, such that the FCIP tunnel acts as an FC InterSwitch Link (ISL) over which encapsulated FC traffic flows.

The FC traffic is carried over the IP network 102 through the FCIP tunnel between the IP gateway device 104 and the IP gateway device 118 in such a manner that the FC fabric 102 and all purely FC devices (e.g., the various source and destination nodes) are unaware of the IP network 102. As such, FC datagrams are delivered in such time as to comply with applicable FC specifications.

To accommodate multiple levels of priority, the IP gateway devices 104 and 118 create distinct TCP sessions for each level of priority supported, plus a TCP session for a class-F control stream. In one implementation, low, medium, and high priorities are supported, so four TCP sessions are created between the IP gateway devices 104 and 118, although the number of supported priority levels and TCP sessions can vary depending on the network configuration. The control stream and each priority stream is assigned its own TCP session that is autonomous in the IP network 102, getting its own TCP stack and its own settings for VLAN Tagging (IEEE 802.1Q), quality of service (IEEE 802.1P) and Differentiated Services Code Point (DSCP). Furthermore, the traffic flow in each per priority TCP session is enforced in accordance with its designated priority by an algorithm, such as but not limited to a deficit weighted round robin (DWRR) scheduler. All control frames in the class-F TCP session are strictly sent on a per service interval basis.

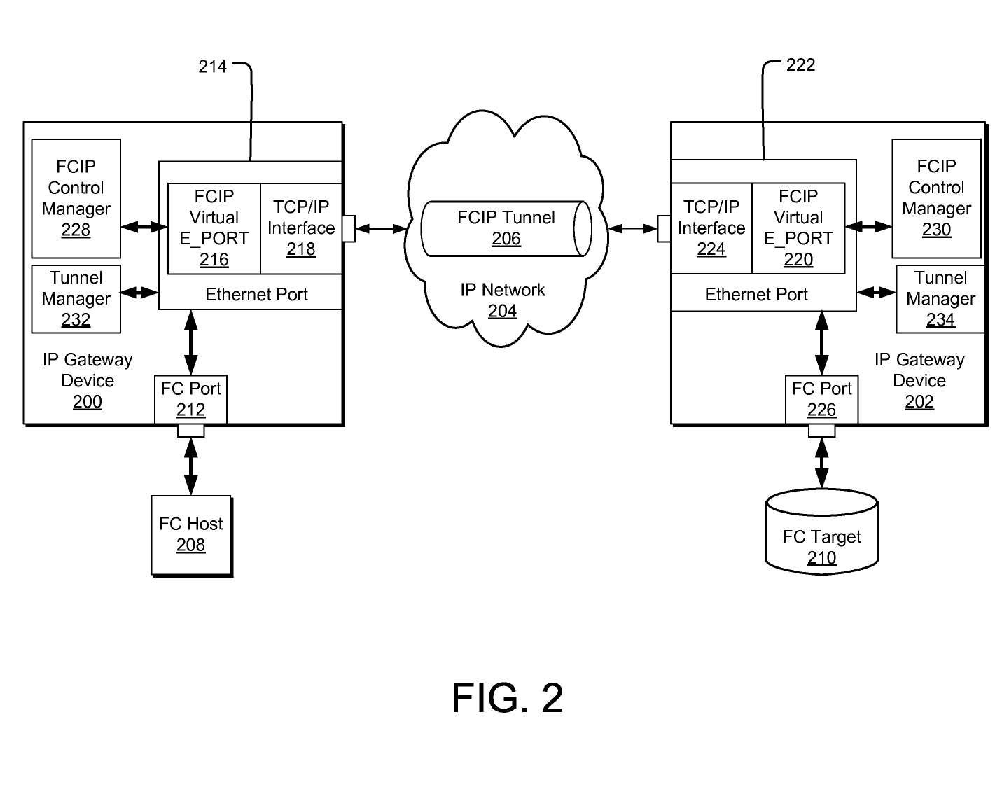

FIG. 2 illustrates example IP gateway devices 200 and 202 (e.g., FCIP extension devices) communicating over an IP network 204 using distinct per priority TCP sessions within a single FCIP tunnel 206. An FC host 208 is configured to send data to an FC target 210 through the IP network 204. It should be understood that other data streams between other FC source devices (not shown) and FC target devices (not shown) can be communicated at various priority levels over the IP network 204.

The FC host 208 couples to an FC port 212 of the IP gateway device 200. The coupling may be made directly between the FC port 212 and the FC host 208 or indirectly through an FC fabric (not shown). The FC port 212 receives FC frames from the FC host 208 and forwards them to an Ethernet port 214, which includes an FCIP virtual E_PORT 216 and a TCP/IP interface 218 coupled to the IP network 204. The FCIP virtual E_PORT 216 acts as one side of the logical ISL formed by the FCIP tunnel 206 over the IP network 204. An FCIP virtual E_PORT 220 in the IP gateway device 202 acts as the other side of the logical ISL. The Ethernet port 214 encapsulates each FC frame received from the FC port 212 in a TCP segment belonging to the TCP session for the designated priority and an IP packet shell and forwards them over the IP network 204 through the FCIP tunnel 206.

The FC target 210 couples to an FC port 226 of the IP gateway device 202. The coupling may be made directly between the FC port 226 and the FC host 210 or indirectly through an FC fabric (not shown). An Ethernet port 222 receives TCP/IP-packet-encapsulated FC frames over the IP network 204 from the IP gateway device 200 via a TCP/IP interface 224. The Ethernet port 222 de-encapsulates the received FC frames and forwards them to an FC port 226 for communication to the FC target device 210.

It should be understood that data traffic can flow in either direction between the FC host 208 and the FC target 210. As such, the roles of the IP gateway devices 200 and 202 may be swapped for data flowing from the FC target 210 and the FC host 208.

Tunnel manager modules 232 and 234 (e.g., circuitry, firmware, software or some combination thereof) of the IP gateway devices 200 and 202 set up and maintain the FCIP tunnel 206. Either IP gateway device 200 or 202 can initiate the FCIP tunnel 206, but for this description, it is assumed that the IP gateway device 200 initiates the FCIP tunnel 206. After the Ethernet ports 214 and 222 are physically connected to the IP network 204, data link layer and IP initialization occur. The TCP/IP interface 218 obtains an IP address for the IP gateway device 200 (the tunnel initiator) and determines the IP address and TCP port numbers of the remote IP gateway device 202. The FCIP tunnel parameters may be configured manually, discovered using Service Location Protocol Version 2 (SLPv2), or designated by other means. The IP gateway device 200, as the tunnel initiator, transmits an FCIP Special Frame (FSF) to the remote IP gateway device 202. The FSF contains the FC identifier and the FCIP endpoint identifier of the IP gateway device 200, the FC identifier of the remote IP gateway device 202, and a 64-bit randomly selected number that uniquely identifies the FSF. The remote IP gateway device 202 verifies that the contents of the FSF match its local configuration. If the FSF contents are acceptable, the unmodified FSF is echoed back to the (initiating) IP gateway device 200. After the IP gateway device 200 receives and verifies the FSF, the FCIP tunnel 206 can carry encapsulated FC traffic.

The TCP/IP interface 218 creates multiple TCP sessions through the single FCIP tunnel 206. In the illustrated implementation, three or more TCP sessions are created in the single FCIP tunnel 206. One TCP connection is designated to carry control data (e.g., class-F data), and the remaining TCP sessions are designated to carry data streams having different levels of priority. For example, considering a three priority QoS scheme, four TCP sessions are created in the FCIP tunnel 206 between the IP gateway device 200 and the IP gateway device 202, one TCP session designated for control data, and the remaining TCP sessions designated for high, medium, and low priority traffic, respectively. Note: It should be understood that multiple TCP sessions designated with the same level of priority may also be created (e.g., two high priority TCP sessions) within the same FCIP tunnel.

The FCIP tunnel 206 maintains frame ordering within each priority TCP flow. The QoS enforcement engine may alter the egress transmission sequence of flows relative to their ingress sequence based on priority. However, the egress transmission sequence of frames within an individual flow will remain in the same order as their ingress sequence to that flow. Because the flows are based on FC initiator and FC target, conversational frames between two FC devices will remain in proper sequence. A characteristic of TCP is to maintain sequence order of bytes transmitted before deliver to upper layer protocols. As such, the IP gateway device at the remote end of the FCIP tunnel 206 is responsible for reordering data frames received from the various TCP sessions before sending them up the communications stack to the FC application layer. Furthermore, in one implementation, each TCP session can service as a backup in the event a lower (or same) priority TCP session fails. Each TCP session can be routed and treated independently of others via autonomous settings for VLAN and Priority Tagging and/or DSCP.

In addition to setting up the FCIP tunnel 206, the IP gateway device 200 may also set up TCP trunking through the FCIP tunnel 206. TCP trunking allows the creation of multiple FCIP connections within the FCIP tunnel 206, with each FCIP connection connecting a source-destination IP address pair. In addition, each FCIP connection can maintain multiple TCP sessions, each TCP session being designated for different priorities of service. As such, each FCIP connection can have different attributes, such as IP addresses, committed rates, priorities, etc., and can be defined over the same Ethernet port or over different Ethernet ports in the IP gateway device. The trunked FCIP connections support load balancing and provide failover paths in the event of a network failure, while maintaining in-order delivery. For example, if one FCIP connection in the TCP trunk fails or becomes congested, data can be redirected to a same-priority TCP session of another FCIP connection in the FCIP tunnel 206. The IP gateway device 202 receives the TCP/IP-packet-encapsulated FC frames and reconstitutes the data streams in the appropriate order through the FCIP virtual E_PORT 220. These variations are described in more detail below.

Each IP gateway device 200 and 202 includes an FCIP control manager (see FCIP control managers 228 and 230), which generate the class-F control frames for the control data stream transmitted through the FCIP tunnel 206 to the FCIP control manager in the opposing IP gateway device. Class-F traffic is connectionless and employs acknowledgement of delivery or failure of delivery. Class-F is employed with FC switch expansion ports (E_PORTS) and is applicable to the IP gateway devices 200 and 202, based on the FCIP virtual E_PORT 216 and 220 created in each IP gateway device. Class-F control frames are used to exchange routing, name service, and notifications between the IP gateway devices 200 and 202, which join the local and remote FC networks into a single FC fabric. However, the described technology is not limited to combined single FC fabrics and is compatible with FC routed environments.

The IP gateway devices 200 and 202 emulate raw FC ports (e.g., VE_PORTs or VEX_PORTs) on both of the FCIP tunnel 206. For FC I/O data flow, these emulated FC ports support ELP (Exchange Link Parameters), EFP (Exchange Fabric Parameters, and other FC-FS (Fibre Channel-Framing and Signaling) and FC-SW (Fibre Channel-Switched Fabric) protocol exchanges to bring the emulated FC E_PORTs online. After the FCIP tunnel 206 is configured and the TCP sessions are created for an FCIP connection in the FCIP tunnel 206, the IP gateway devices 200 and 202 will activate the logical ISL over the FCIP tunnel 206. When the ISL has been established, the logical FC ports appear as virtual E_PORTs in the IP gateway devices 200 and 202. For FC fabric services, the virtual E_PORTs emulate regular E_PORTs, except that the underlying transport is TCP/IP over an IP network, rather than FC in a normal FC fabric. Accordingly, the virtual E_PORTs 216 and 220 preserve the “semantics” of an E_PORT.

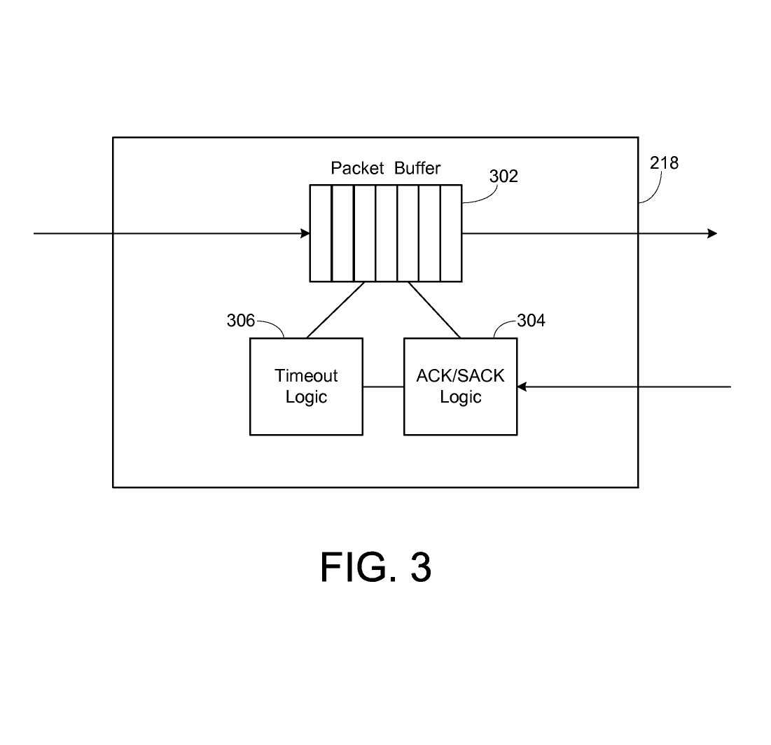

FIG. 3 is a logical block diagram of portions of the TCP/IP interface 218 according to the preferred embodiment. It is noted that this is a logical representation and actual embodiments may implemented differently, either in hardware, software or a combination thereof. A packet buffer 302 holds a series of TCP/IP packets to be transmitted. As is normal practice in TCP, the packets are not removed from the buffer until either an ACK for that packet is received or the packet times out. A ACK/SACK logic block 304 is connected to the packet buffer 302 and receives ACKs and SACKs from the IP network. The ACK/SACK logic block 304 is responsible for directing packets be removed from the packet buffer 302, such as by setting a flag so that the packet buffer 302 hardware can remove the packet. A timeout logic module 306 is connected to the packet buffer 302 and the ACK/SACK logic module 304. The timeout logic module 306 monitors the period each of the TCP/IP packets have been in the packet buffer 302 so that after the timeout period, as well known to those skilled in the art, timeout operations can proceed based on the particular TCP/IP packet being considered lost or otherwise not able to be received. The timeout logic module 306 is connected to the ACK/SACK logic module 304 to allow the ACK/SACK logic module 304 to monitor TCP/IP packet timeout status.

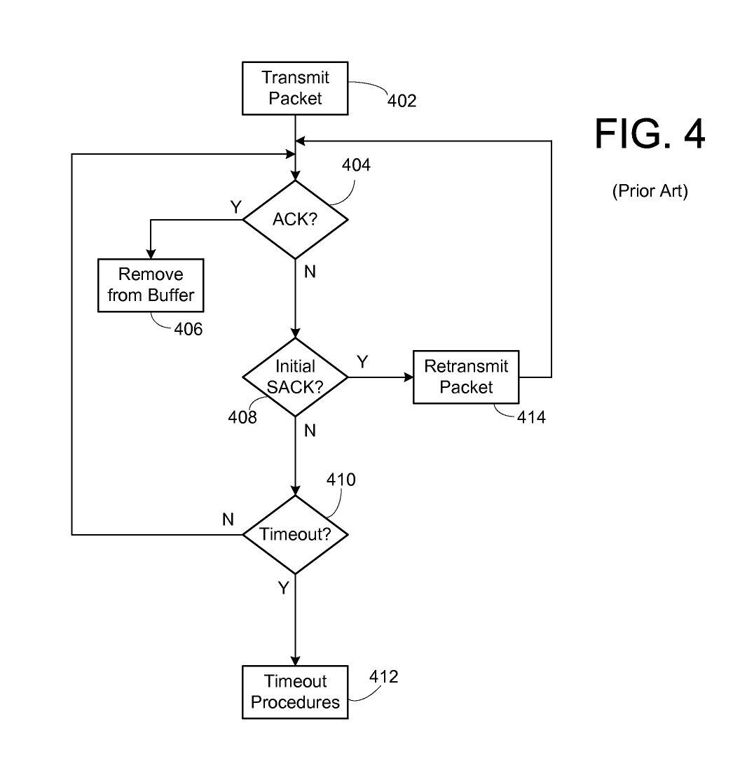

FIG. 4 illustrates prior art operations relating to ACK and SACK indications. FIG. 4 is a flowchart for clarity in understanding the embodiment, but it is noted that the actual operation of the various modules need not be sequential as indicated by the flowchart but would commonly be running in parallel, such as timeout operations proceeding in parallel with ACK and SACK operations.

In step 402 a TCP/IP packet is transmitted to the IP network. In step 404 it is determined if an ACK has been received for that TCP/IP packet. If so, in step 406 the packet is removed from the buffer. If not, in step 408 it is determined if an initial SACK has been received that indicates that the packet needs to be retransmitted. If not, in step 410 it is determined if the packet has timed out. If not, operation returns to step 404 to continue monitoring. If the packet has timed out, in step 412 timeout procedures are started.

If a SACK has been received, indicating the need for the packet to be retransmitted, in step 414 the packet is retransmitted. Operation returns to step 404 to continue monitoring.

Thus it can be seen that in prior art operation, a packet is only retransmitted once.

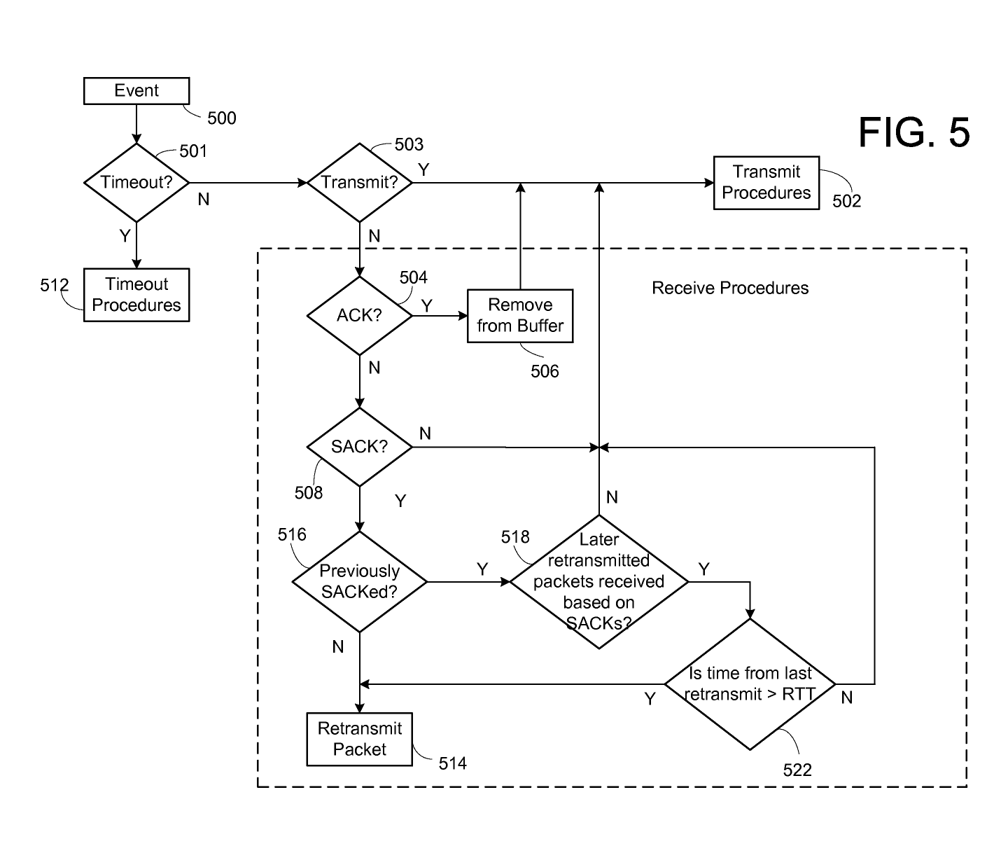

FIG. 5 is a flowchart of operations according to the present invention. In general many of the steps are similar, so the steps have been numbered similarly to FIG. 4. An event of some type occurs at step 500. Example events are need to transmit a packet, receive an ACK or SACK and the like. In step 501 it is determined if the event is a timeout. If so, timeout procedures of step 512 are performed. If not a timeout, step 503 determines if the event is a transmit. If so, transmit procedures are performed in step 502. If not a transmit, step 504 determines if an ACK has been received. If so, step 506 removes the packet from the buffer and operation proceeds to transmit procedures to continuing waiting. If not an ACK, step 508 determines if a SACK has been received. If a SACK is received, in step 516 it is determined if this packet has been previously SACKed, i.e. this is the second or higher time the packet has been indicated in a SACK. If not, then operation proceeds to the retransmit step of 514, as in FIG. 4. If the packet has been previously SACKed, operation proceeds to step 518 to determine if later retransmitted packets have been received based on the contents of the SACKs, and potentially ACKs. This would indicate that, in general, there is communication between the gateways, but some problem is occurring with the one packet. For example, assume that packets 1, 5 and 6 are indicated in the first SACK and are retransmitted, for example before packet 9. A second SACK comes in indicating packets 1, 11 and 12. Packets 11 and 12 are retransmitted as normal but packet 1 receives different handling as this is the second SACK and later retransmitted packets 5 and 6 have been indicated as being received. This later retransmitted packets having been received condition indicates there is connectivity and packet transfer in general, but some specific problems are occurring. Alternatively, if ACKs are received for packets 5 and 6, the same conclusion can be reached. If no later retransmitted packets are determined as being received, operation proceeds to step 502 to continue monitoring. However, if later retransmitted packets have been successfully received, operation proceeds to step 522 to determine if the time from the last retransmission is greater than the round trip time (RTT) for a packet. If so, operation proceeds to step 514 to retransmit the packet. If not, operation proceeds to step 502 to continue monitoring.

Therefore the packet determined from step 518 is periodically retransmitted until either an ACK is received or the packet times out. This periodic retransmission greatly increases chances of the packet being acknowledged in many circumstances, such as IP network rerouting and other transient phenomena. If the packet is acknowledged, then timeout procedures do not have to be performed and the overall transmission operation is improved. For the above mentioned FCIP operations, this means that effective storage operations proceed at a much higher rate than if a timeout had occurred.

The embodiments of the invention described herein are implemented as logical steps in one or more computer systems. The logical operations of the present invention can be implemented (1) as a sequence of processor-implemented steps or (2) as interconnected machine or circuit modules or (3) some combination of processor-implemented steps and circuit modules. The implementation is a matter of choice, dependent on the performance requirements of the system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. An apparatus comprising:
a buffer holding a plurality of transmitted TCP packets;
timeout logic coupled to said buffer for indicating that a TCP packet held in said buffer has timed out; and
acknowledgement logic coupled to said buffer and said timeout logic for receiving acknowledgements and selective acknowledgements for TCP packets held in said buffer, said acknowledgement logic directing repeated retransmission of at least one of the TCP packets held in said buffer in response to receiving at least two selective acknowledgements indicating the need to retransmit said at least one TCP packet until either an acknowledgement for said at least one TCP packet has been received or an indication is provided that said at least one TCP packet has timed out.

2. The apparatus of claim 1, wherein said acknowledgement logic further directs removal of a TCP packet from said buffer if an acknowledgement is received indicating that said TCP packet has been successfully received.

3. The apparatus of claim 1, wherein said directing repeated retransmission of said at least one TCP packet includes determining that TCP packets transmitted after a first retransmission of said at least one TCP packet were properly received.

4. A method comprising:
transmitting a plurality of TCP packets;
receiving at least two selective acknowledgements indicating that at least one of said plurality of TCP packets needs to be retransmitted; and
repeatedly retransmitting said at least one TCP packet based on said receipt of at least two selective acknowledgments until either an acknowledgement for said at least one TCP packet is received or said at least one TCP packet times out.

5. The method of claim 4, further comprising:
receiving acknowledgement or selective acknowledgement that a TCP packet has been successfully received; and
indicating that said TCP packet can be removed from a buffer as retransmission is not required.

6. The method of claim 4, wherein said repeatedly retransmitting said at least one TCP packet includes determining that TCP packets transmitted after a first retransmission of said at least one TCP packet were properly received.
